(19) United States
(12) Patent Application Publication
(10) Pub. No.: US 2007/0041041 A1
(43) Pub. Date: Feb. 22, 2007

(54) Method and computer program product for conversion of an input document data stream with one or more documents into a structured data file, and computer program product as well as method for generation of a rule set for such a method

(76) Inventors: Werner Engbrocks, Poing (DE); Georg Landmesser, Haar (DE); Matthias Fromm, Markt Schwaben (DE)

Correspondence Address: SCHIFF HARDIN, LLP;PATENT DEPARTMENT, 6600 SEARS TOWER, CHICAGO, IL, 60606-6473, US

(21) Appl. No.: 11/294,595

(22) Filed: Dec. 5, 2005

(30) Foreign Application Priority Data
Dec. 8, 2004 (DE) 10 2004 059 120.2
Jun. 30, 2005 (DE) 10 2005 030 645.4

(51) Int. Cl. G06F 3/12

(52) U.S. Cl. 358/1.15; 358/1.13

(57) ABSTRACT

In a method, a computer program product and a system for conversion of an input document data stream with one or more documents into a structured data file, source data fields in an input document data stream are automatically positioned for readout of data to be extracted, whereby their positioning occurs by means of absolute or relative addressing. The source data fields are positioned by means of source data regions with which sections of the individual documents are detected. These source data regions are arranged nested and can in turn themselves be positioned absolutely or relatively. The corresponding rules are created in simple fashion via marking of the corresponding source data regions and source data fields in the template document.

### BACKGROUND

The preferred embodiment concerns a method for conversion of an input document data stream with one or more documents into a structured data file for generation of an output document data stream, and a computer program product for generation of a rule set for such a method.

A method and a device for processing of a document data stream of one input format into an output format is known from WO 2004/040432 A1. The input document data stream is converted into normalized data by means of a translation stage module. The translation stage module is controlled by a rules file. The rules file contains mapping rules that are formed from the input document data stream and/or, if applicable, a new design data set to be created and/or from input data-specific auxiliary files. Both the design data set and the rules file can be freely editable. The design data set can be formed from the input data set and/or from input data-specific auxiliary files and can additionally be used in the formation of a document template that controls the formatting of the normalized data. As an alternative to this, the rules file can also be directly acquired from the input document data stream or other file information from auxiliary files.

The mapping rules specified in the rules file are specifically for the input document data stream. They specify which element of the input document data stream is to be associated with which elements of the design data set. The design data set contains the structure definition of the normalized data, whereby type declarations are provided for various structure elements, for example for customer numbers, names, logos etc. Data groups that belong together (in particular all those data that belong to a document) can then also be formed in the normalized raw data. All associated data in the normalized raw data stream are thus available for each document. A document template serves as a structure pattern for the documents to be generated and describes which formatting instructions are to be added into the normalized data stream. It can contain elements from the design data set and/or freely-programmable static or dynamic elements. The document template serves to control the format formation device (formatter or document composition engine). A resource-oriented data stream is formed per document by the formatter from the normalized raw data stream. Insofar as formattings were already contained in the raw data these are retained, and insofar as the raw data are unformatted and formatting specifications regarding the corresponding data fields are contained in the document template, these are added in a resource-oriented manner in the formatter, whereby resources that are required multiple times within one data stream are further-processed, i.e. are primarily inserted into the resource-oriented data stream via calling of the resources, whereby the resources themselves are only internally present once or are loaded externally from a resource file or can also only be referenced.

In this method, the generation of the rules file is elaborate and requires significant software knowledge.

Adobe Systems, Inc., USA offers a product under the product designation Adobe Central Pro Output Server with which it is also possible to automatically convert an input document data stream into a data file. The rules hereby used can be input by a user by means of a graphical user interface, whereby a template document is shown on the user interface. Individual fields of the template document can be selected by the user and any type declaration can be associated with them. Specific sections in a document that occur repeatedly can also be defined. These sections are established using a rule set that detects the section type in the input document data stream and then reads out the corresponding fields. These sections respectively extend over the entire page width.

Upon execution of the automatic conversion of the input document data stream into the data file, all data that are not be read out are removed from the input document data stream, and the data to be read out are stored in the data file in the same order as in the input document data stream, whereby a type declaration is respectively added to the individual data. In this known method, a data file is thus obtained in which the individual data are successively listed in the same order as in the input document data stream.

A significant need exists to convert (in an optimally flexible manner) input document data streams from systems that have been used for a long time (that, however, should be used further for safety-relevant reasons) into output document data streams. Such systems used for a long time are primarily used in banks and insurance companies and are generally designated as legacy applications. These systems often possess only very limited formatting possibilities, and the data are frequently output as what is known as an ASCII line data stream that essentially contains only characters as well as line and page breaks. However, it is desired to represent these data in a modern format relative to that of the customer.

In the product Adobe Central Pro Output Server, a general data file is created that is suitable for different output document data streams. However, it has been shown that the data list hereby generated is only conditionally suitable for the further processing since the detection of individual data that are arranged in the same order in the original document can prove to be very difficult.

The generation of the rule sets is also very elaborate in the aforementioned method, in particular when the documents of the input document data stream possess complex structures such as, for example, tables.

### SUMMARY

It is an object as to a first aspect of the preferred embodiment to achieve a method and a computer program product for conversion of an input document data stream with one or more documents into a data file for generation of an output document data stream, which method yields a data file that can be very flexibly and simply converted into an arbitrarily formatted output document data stream.

It is also an object as to a second aspect of the preferred embodiment to achieve a method and a computer program product that enables a simple input of rules for conversion of an input document data stream into a structured data file.

A method is provided for conversion of an input document data stream with one or more documents into a structured data file for generation of an output document data stream. Data are extracted from an input document data stream according to a predetermined rule set and the data are stored in the structured data file. The field names are associated with individual data fields in the structured data file and the data fields are structured in a plurality of data levels. The rule set is designed such that arbitrary data from the input document data stream are mapped to an arbitrary data field of the structured data file.

### BRIEF DESCRIPTION OF THE DRAWINGS

FIG. 1 illustrates a high-capacity printing system;

FIG. 2 shows schematically the association of source data regions and source data fields in an input document with generic terms and data fields in a tree structure;

FIG. 3 shows schematically data of an input document that are suitable for detection of a page type;

FIG. 4 shows schematically data of an input document that are suitable for detection of document borders;

FIG. 5 illustrates data of an input document to be extracted, which data can be arranged within source data regions and also outside of source data regions;

FIG. 6 shows schematically an input document in which problems possibly occurring given absolute addressing of source data fields are shown;

FIG. 7 illustrates an input document in which specific source data regions are addressed by means of initial position elements;

FIG. 8 shows a section of an output document;

FIG. 9 shows a section of the input document of the file “Lieferschein.txt”, namely the pages 1, 2 and 6 through 8;

FIG. 10 shows a screen representation for a first page of a template document and a corresponding tree structure; and

FIG. 11 shows a screen representation corresponding to FIG. 10 with a following page of the template document.

### DESCRIPTION OF THE PREFERRED EMBODIMENT

In the method of the preferred embodiment for conversion of an input document data stream with one or more documents into a structured data file for generation of an output document data stream according to a first aspect, data are extracted from the input document data stream according to a predetermined rule set and are stored in the structured data file, whereby in the structured data file field names or type declarations are associated with the individual data fields, the data fields are structured in multiple data levels, and the rule set is designed such that any data from the input document data stream can be mapped to any data field of the structured data file. In particular a process logic stored in a computer system is thereby considered.

With the method of the preferred embodiment, any data of the input document data stream of a document can be mapped to any data fields of the structured data file, in particular in the framework of the process logic. The structured data file thus contains data classified according to arbitrary points of view predetermined by the user, which data can also be structured in multiple data levels. This structured data file thus represents a type of databank in which the data are arranged in a tree structure predetermined by the user.

Methods for printing of data from databanks sufficiently known and arbitrary formats can hereby be used.

Via the generation of a structured data file, a databank that can be very flexibly further processed in a printing process is provided from the input document data stream.

The preferred embodiment is based on the realization that a reverse process corresponding to the generation of the data can be described and controlled via the production of structured definitions for processing of input document data streams of the aforementioned type (in particular of what are known as line data streams that can be coded as ASCII) or also of Advanced Function Presentation (AFP) data streams, whereby the original data structure (in particular the structure of databank data) can be regained. The reverse process then specifies how the page and document structures generated from a formatting process must be interpreted in order to regain the underlying useful data (including their superordinate group structures) forming the basis of the formatting process, in particular in a legacy application. In particular a tree structure that is generated and advantageously utilized according to the second aspect of the preferred embodiment serves as a graphical aid for definition of the structure.

The method of the preferred embodiment of the second aspect of the preferred embodiment, which can be executed in combination with or also independent of the first aspect of the preferred embodiment, is designed such that individual rules of the rule set are created in that a template document is shown on a graphical user interface in one window and data fields in a tree structure are shown in another window, and a marking region and/or a source data field is respectively defined via marking of in particular data in the template document that logically belong together. A structure element corresponding to the marking region or the source data field is thereby assigned to the marking region or the source data field, and this structure element is in particular reproduced in the tree structure and/or linked with this. Given linking of such a source data field or such a marking of the template document with a data field, a rule is furthermore in particular automatically created with which a source data field or a group of source data fields corresponding to the marking is read out from the input document data stream, and its content is stored in the corresponding data field or structure element according to the structured data file.

Variables such as, for example, fields or table variables for the structured data file (into which source data fields of the input document data stream can be read to form the structured data file) can be specified with the structure elements of the tree structure.

The computer program product of the preferred embodiment for creation of a rule set for the method according to the second aspect comprises a graphical user interface with multiple windows, whereby a template document that corresponds to the format of the documents contained in the input document data stream can be shown in one window and the data fields can be arranged in a further window in a tree structure that can comprise multiple levels. According to the second aspect, a source datum of the template document is marked with graphical structure or source data of the template document that logically belong together is mutually marked as a region belonging together, and at least one structure element corresponding to the marking region is assigned to the marking region.

According to the second aspect, in particular structure are provided for definition of one or more source data fields and for linking of the same with one or more structure elements, in particular with the data fields. Given such a linking, a rule is in particular automatically created for readout of one or more source data fields from the input document data stream and for storage of its contents in the structured data file in the corresponding data field or data fields. The structure elements assigned to the marking region are in particular also assigned to the tree structure.

The computer program product corresponding to the second aspect provides the user with at least two windows on the graphical user interface, whereby the template document is shown in one window and the tree structure (whose structure elements (such as, for example, data fields) the user can show, insert, change and/or delete in a computer-aided manner) is shown in the other window. The user can hereby himself create the tree structure; its structure elements can be created automatically or semi-automatically. However, an already-existing structure can also be adopted, and in particular a structure can be selected from a plurality of predetermined template structures. The source data fields in the template document can be linked with simple structure with the structure elements designed as structured data fields, whereby a rule is respectively, automatically created.

This computer program product thus allows a fast and simple creation of a rule set for conversion of an input document data stream into a structured data file.

A tree structure in the sense of the present preferred embodiment, is any structure in which one or more data fields can respectively be subordinate to a generic term, i.e. a superordinate structure element. These generic terms can in turn be subordinate to further generic terms. Such a tree structure thus comprises branches, whereby generic terms are respectively arranged as superordinate structure elements at the branching points (nodes) of the branches, and the end points of the branches are represented by data fields as subordinate structure elements. Such a data structure can comprise a plurality of branching levels, whereby structure elements such as, for example, data fields can be arranged in each level.

It is advantageous for the second aspect that a corresponding, simple and intuitive-to-operate user interface can be operated with the graphical elements such as the tree structure and/or the structure for marking of regions of the template document, with which user interface structural information of the original useful data (such as, for example, its origin) can be regained from one and the same field of a databank.

Structure elements according to the second aspect are in particular associated with a branch in the tree structure and in particular represent a branching point in the tree structure. A plurality of further structure elements (sub-branches) can thus be subordinate to the structure element. Relative to the data, such a branch can be mapped as an object with multiple subordinate instances. An element corresponding to a page type, a data field, a table or a region comprising a plurality of data fields can thereby be associated as a structure element.

In a preferred exemplary embodiment of the second aspect, the template document is represented in rows and columns, whereby the marking region is freely selectable in rows and columns.

In a further preferred exemplary embodiment of the second aspect, in the template document a repeat element (such as, for example, an enumeration point in a numerical enumeration) is selected that is characteristic for a recurring structure in the template document (what is known as a repeat structure) and characteristic data of the repeat element (in particular characteristic, format-related data such as line and/or column position within a predetermined region in the template document and/or a text content) are detected manually, semi-automatically or automatically. With the characteristic data a repeat rule can then be formed with which all associated data of a repeat structure can be detected in the template document and/or in the input document data stream.

A pointer device such as, for example, a mouse or a cursor is provided for selection of an element such as, for example, a source data field or a region within the template document. Furthermore, given actuation of a first button (such as, for example, the right mouse button of the input device), available assignment possibilities (such as, for example, the structure element “region” or a repeat element) available regarding this element or region can be automatically displayed relative to context. Furthermore, at least one associable element and/or at least one associatable region in the template document can be automatically displayed emphasized in the template document dependent on the position of such a pointer device and in particular on the actuation of a second button of such an input device. The user-friendliness of the method or of the computer program product is thereby further increased.

When a repeat region comprising a plurality of data is marked in the template document, a structure element (such as, for example, a field (ARRAY) comprising a plurality of data fields and in particular a plurality of entries regarding the data fields) corresponding to the selection can be associated with this repeat region (made in particular dependent on a selection made in a menu-driven manner by an operating personnel). When a field (ARRAY) comprises a plurality of data fields, for example for invoice items, it then in particular contains equally many entries regarding all data fields, namely one entry in all of its data fields regarding each invoice item.

An END condition can be established automatically, semi automatically (menu-driven) or manually for the marked region and/or a repeat region. In particular a branch in the tree structure can be placed as a structure element and a field of the type ARRAY that corresponds to the branch can be placed in the structured data file. In particular a plurality of data fields as subordinate structure elements are associated with a branch in the tree structure. For creation and/or expansion of the tree structure, in particular new data fields can alternately be established first and then be associated with the superordinate branch, or the branch can be established first and the new subordinate data fields can be associated with it.

A repeat element can in particular be formed by one or more characters, a table, a document line or a document column. The repeat element can be situated in a marked region and in particular comprise the entire marked region. It can be established before or after the creation of the region belonging together. Using the structural characteristic features of the repeat element, data of the repeat structure can be automatically determined and/or marked displayed in the repeat template document and/or in the input document data stream. When the marking range contains source data fields and these are linked with at least one structure element (designed as a data field) of the tree structure, given such a link a rule can be automatically created for readout of a source data field from the input document data stream and for storage of its content in the structured data file in the corresponding data field.

Given establishment of a repeat structure or of a repeat element in the template document, it can be decided (in particular automatically or by manual selection) whether a new structure element corresponding to the repeat structure or the repeat element is to be subsequently added in an existing tree structure. Data fields of the tree structure that are associated with the repeat structure are in particular associated with the new structure element as a sub-structure element.

The preferred embodiment, in particular enables multiple marking regions in the template document to be marked that in particular are nested within one another in levels. The nesting can thereby in particular occur spanning across levels.

With regard to the marking region, a finding rule (in particular specified in row-and-columns position coordinates) in which in particular one repeat element and/or one repeat condition are specified can be created to find repeat structures. The data structure contained in the marking region repeatedly occurs in the template document in repeat structures. The finding rule specifies at which positions data of the template document are to be associated with the marking region. A finding rule can, for example, have content that a point in a specific column is sought, that a character string with a specific content and/or a specific length occurs in or as of a specific row or column, or the like.

The assignment of the structure element for marking can in particular occur automatically using a structure element present in the template document such as, for example, specifications/variables of the type page type (page type), table (table, field (field) or region (area).

An END condition can in particular be automatically generated for a marked region. When two regions are nested one inside the other and in particular a second marked region is subordinate to the first marked region, the END condition of the superordinate second region can then in particular be automatically adopted for the first marked region. Furthermore, an end condition for a marked region can be generated and/or changed via a data-driven condition, in particular via a control variable or a condition established (in particular semi-automatically in a menu-driven manner) by an operating personnel. Such a condition can, for example, contain that the marked region ends after N rows. An operating personnel has creation, alteration and deletion authority over all rules of the rule set and/or the tree structure via a menu navigation, in particular semi-automatically and in particular effective in the framework of stored, system-inherent logical rules.

When, according to a particularly preferred embodiment, all regions of the data stream that belong to a common structure element are similarly marked, in particular with the same color, using the structure elements generated in the tree structure within a data stream simultaneously or successively shown in the first window (which data stream contains at least one complete template document) the tree structure and the rules connected with it can be easily and clearly checked. To check the rule set for the data shown in the first window, the rules of the rule set are in particular applied to these data. The application of the rules to the data shown in the first window can also in particular be graphically illustrated. Regions of various levels and/or types can thereby be variously marked (in particular with various colors) in the data shown in the first window.

To check the correctness of a structure element, in particular a structure element displayed in the tree structure of the second window can be selected and all regions shown in the first window that are associated with this structure element are automatically displayed. In a further improved exemplary embodiment, with regard to a structure element selected in a second window the structure elements (or the symbols corresponding to the hierarchical classification) associated with the structure element and superordinate and/or subordinate in levels are displayed.

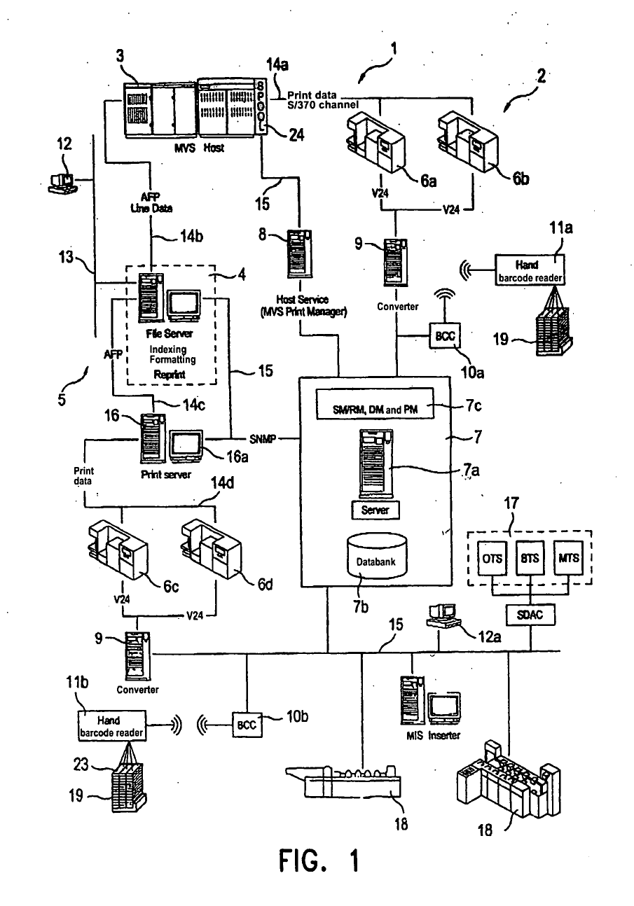

A document print production system 1 is shown in FIG. 1 that comprises a mainframe architecture 2 on the one hand and a network architecture 5 on the other hand, in which network architecture 5 document data or document print data streams are respectively generated by means of user programs (tools). In the mainframe architecture 2, these print data are generated by a host computer, for example as a line print data stream (ASCII line data). The print data can alternatively be directly transferred from the host computer 3 to one or more printing apparatuses 6a, 6b via what is known as an S/370 channel 14a. As an alternative to this output channel, the print data can also be transferred from the host computer 3 via a network 13 or a direct data connection 14b to a processing computer 4 in which the print data are cached (for example an associated file server) and processed for subsequent output steps. In such host computers 3, in particular print data streams are generated that comprise larger data sets (databanks) regular list expressions, calculations, consumption summaries (for telephone bills, gas bills, bank accounts) etc. Such applications have frequently already been used for many years and are required as before in a more or less unchanged manner (what are known as legacy applications).

Within the mainframe architecture 2, the print production workflow is monitored by a monitoring system 7. It comprises a monitoring computer 7a that is coupled with a databank 7b and contains various computer program modules 7c.

The monitoring system 7 is connected via a device control network 16 and a print manager module 8 with the host computer 3 as well as via a converter 9 with, for example, a V24 data line that connects to both print devices 6a, 6b. The converter 9 converts the V24 signals into DMT protocol signals of the device control network 15. SNMP protocol signals can be provided (converted as DMT protocol signals) to a device manager DM or be directly transferred as SNMP protocol signals.

Print products 19 that have been generated in the printers 6a, 6b from the document print data stream and are printed with a barcode can respectively be scanned with a manually movable, radio-controlled barcode reader 11a. Signals are transferred via radio to the read station 10a and transmitted into the device control network 15 or to the monitoring system 7.

In the network architecture 5, document data are generated by means of user programs in client computers 12, 12a that are connected among one another via a client network 13 as well as with the processing computer (file server) 4. The file server thus serves as a central processing and handling interface for print data of the entire print production system 1. Diverse control modules (software programs) run on it, via which control modules the entire print production workflow or the entire document processing is optimally adapted to the respective conditions in a manner specific to the usage, relative to the production and controlled on the part of the device. From WO 2004/040432 it is known that in particular the following functions are executed at the file server:
converting, indexing, sorting
insertion of control information
data reduction
extraction for generation of a compressed data stream, in particular for monitoring of the participating devices in real time,
repeat printing (reprint)

These functions are explained in detail in WO-A1-2004/040432. WO-A1-2004/040432 is therefore referenced with regard to the entire content. This patent application is incorporated into the present patent application.

Print data that were produced by the processing computer 4 are conducted over the print data line 14c to a print server 16. Its task is essentially to unload the processing computer 4. The print server 16 comprises a screen 16a. The print server 16 is primarily integrated into the overall system for reasons of performance (speed). In systems whose print speed is less great, the print server 16 can also be omitted.

On their processing path between the print device 6 and a post-processing device 18, the printed documents are tested with a test system 17 with regard to various criteria, namely by an optical test system with regard to their optical print quality, with a barcode test system with regard to their existence, their consistency and/or their order, and with an MICR test system insofar as the print was printed by means of magnetically-readable toner (magnetic ink character recognition toner). The data delivered from the test system 17 are transmitted by a serial data acquisition module to the device control network 15 and supplied to the monitoring system 7.

The method of the preferred embodiment, for conversion of an input document data stream with one or more documents into a structured data file for generation of an output document data stream can be executed on the host computer 3 at which the input document data stream is generated. However, it is more appropriate to execute the method of the preferred embodiment, for conversion of an input document data stream into a structured data file at a computer (such as, for example, the file server 4 or the print server 16) downstream from the host computer, whereby no intervention must be made in the former system which processes a large quantity of sensitive data.

With the method of the preferred embodiment, an input document data stream with one or more documents is converted into a structured data file for generation of an output document data stream. A structured data file generated from an input document data stream is described in the German patent application 10 200 021 269.4 which bears the title “Verfahren, Vorrichtung und Computerprogramm zum Erzeugen eines seiten—und/oder bereichsstrukturierten Datenstroms aus dem Zeilendatenstrom”. This patent application is referenced with regard to its entire content and it is incorporated into the present patent application.

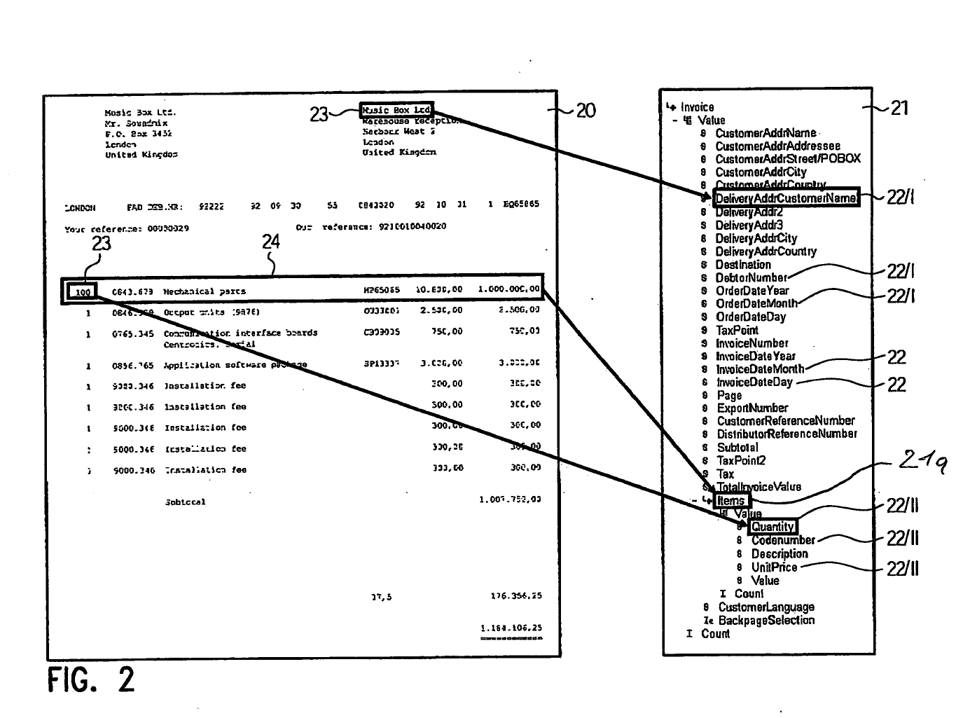

FIG. 2 shows a section of a template document 20 as well as a section of a tree structure 21 with data fields 22.

The template document 21 is a document that is formatted like the documents of an input document data stream to be processed.

This template document 20 and the corresponding input document data stream represent a line data stream that is also called a line data-based print data stream. Such a line data stream merely comprises characters that are encoded (ASCII, EBCDIC, Unicode, DBCS, . . . ) by means of one or more character tables (code pages) and comprise line breaks and page breaks. They can also comprise still further formatting elements. Such line data streams are propagated in many cases in the digital printing field and in particular are designed as an Advanced Function Presentation (AFP) line data stream that was developed by the International Machine Corporation (IBM) or as a line-coded data stream (LCDS) that was developed by the Xerox Corporation. The line and page breaks can be established by a specific character sequence at the line end or page end, control characters at the line or page start or by a fixed, defined character count within a line or line count within a page.

For the present exemplary embodiment it is essential that the formatting (i.e. the arrangement of the individual characters in the document) is determined merely via the position of the individual character in a line, line breaks and page breaks. In such documents, a non-proportional font is used such as, for example, Courier, in which the center-to-center spacing of two adjacent characters is always identical, independent of the type of the respective character.

The tree structure 21 is a file editable by the user, which file contains at least all data fields 22 for a document (here: “Invoice”) in a structured arrangement. The file tree structure serves as a template for generation of a structured data file. This means that no data extracted from the input document data stream is saved in the file tree structure; rather, the data extracted from the input document data stream are stored in the structured data file in the same structure as in the file tree structure, whereby the designation of the corresponding data field of the tree structure is associated with the extracted data as a type declaration.

The tree structure of the present exemplary embodiment is initially sub-divided into two branches that are designated with “Value” or “Count”. The branch “Count” contains merely a single data field that is designated as “Count” and in which the number of the document within an input document data stream is stored in the structured data file. It is thus possible that data of a plurality of documents can be stored structured in a structured data file. The data fields in which the data to be extracted from the input document data stream are written are contained in the branch “Value”. A series of data fields 22/I are directly arranged in the tree structure under the generic term “Value”. These data fields 22/I serve for storage of a datum of the input document data stream that occurs only a single time in each document. In the present example, the name of the delivery address in the template document 20 reads “Music Box Ltd”, which is mapped to the data field “DeliveryAddrCustomerName”, meaning that this name of the delivery address is stored in the structured data file at the corresponding point and is provided with the type declaration “DeliveryAddrCustomerName”.

A further branch that is designated as “Items” is contained in the structure level that contains the data fields 22/I. This branch is in turn branched into a branch “Value” and into a branch “Count”. These subordinate branches serve to structure groups of data fields 22/II to which multiple data of an individual document are mapped. In the present example, the document is thus a bill in which a plurality of objects (items) to be billed are listed for which the data set code number, description, individual price and value are respectively contained in the document. For each such item, a corresponding set of data fields in which the respective values are stored must be generated in the structured data file. The number of these sets of data fields is stored in the data field “Count” that is subordinate to the generic term “Items”.

With the method of the preferred embodiment, data are extracted from the input document data stream according to a predetermined rule set and stored in the structured data file, whereby the rule set is designed such that arbitrary data from the input document data stream can be mapped to an arbitrary data field of the structured data file.

To generate such a rule set, structure is provided with which source data fields 23 and source data regions 24 can be defined in the template document. For simplification of the representation, only two source data fields 23 and one source data region 24 are shown in FIG. 2.

The content of the source data fields 23 is mapped to the data fields 22, and source data regions 24 can (however do not have to) correspond to generic terms, meaning data fields of superordinate structure elements in the tree structure 21. However, for each generic term of the tree structure data are mapped multiple times to its data fields 22/II, a corresponding source data region 24 must be provided in the template document, which source data region 24 is then used once or multiple times for mapping of the data in the actual document of an input document data stream.

If a source data region 24 is detected multiple times within a document in the input document data stream, a data set is generated correspondingly often in the structured data file as an instance with the corresponding data fields. The rule set defining this source data region is thus applied multiple times to the respective document in order to extract data and to store them in the structured data file.

The source data fields 23 and the source data regions 24 are defined in the template document, for example via marking of the corresponding character sequence or the corresponding region. This marking can occur graphically via the drawing of boxes (as it is shown in FIG. 2) by means of a computer mouse. As it is known from text processing programs, the marking of these source data fields 23 or source data regions 24 can also occur via marking of the corresponding characters in the template document by means of pressing a predetermined button and actuation of a corresponding arrow key of a keyboard. For the preferred embodiment, it is significant that a user can mark arbitrary character sequences as source data fields 23 in the template document and can mark regions that contain one or more source data fields 23 as source data regions 24.

The marking of a source data field 23 or of a source data region 24 can occur aided by a computer, also in particular in that the source data field 23 next to the cursor or mouse pointer and/or a next source data region 24 is automatically emphasized in a suitable manner (for example via indication of the source data field 23 or the source data region 24 in a highlight color) dependent on the position of a cursor or a mouse pointer in the template document. This highlighting can occur either automatically, dependent on the position of the pointer device (cursor, mouse) or semi-automatically given actuation of a corresponding button such as, for example, a right mouse button or a function key on a keyboard.

Given generation of the rules, the association of the source data fields 23 with the corresponding data fields 22 occurs, for example, via successive clicking of a source data field 23 and a corresponding data field 22 with the computer mouse or via dragging of an (in particular imaginary, i.e. not displayed on the screen) connecting line. Such an association can naturally also be input via the keyboard and/or be relative to context or menu-driven. Dependent on the position of a cursor or mouse pointer device and in particular dependent on the actuation of a second key on the keyboard or mouse, a structure element corresponding to the source data field 23 or to the source data region 24 can thereby be automatically displayed for the tree structure 21 and offered for selection.

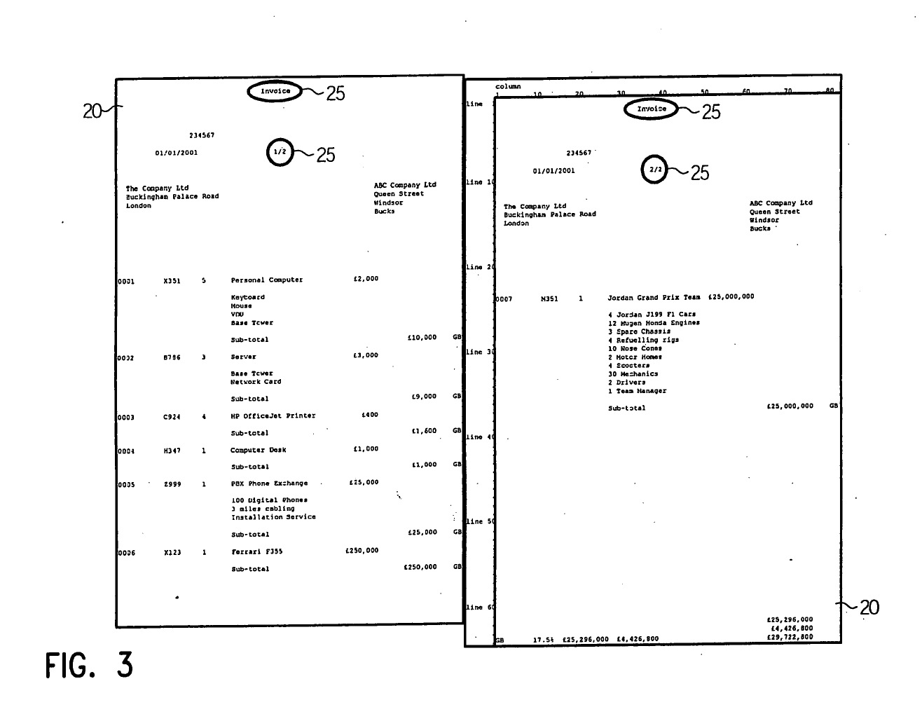

The method of the preferred embodiment, operates per page, meaning that a specific rule set must respectively be drawn upon for conversion of a specific page. So that the selection of the respective rule set can occur automatically, in the generation of the same one or more conditions are to be specified that respectively associated a specific rule set with a specific page of a document. FIG. 3 shows two pages of a template document that respectively contain the term “Invoice” in their header lines, whereby a pair of lines, respectively separated by a “/”, are arranged below the page number and the total line number. These elements represent page type fields 25 that, like the source data fields 23 in the template document, can be defined by the user. For example, if there are three rule sets for billings, one for the first page, one for the last page and one for additional pages, the conditions for the first page would say: if the page contains the datum “Invoice” in a page type field 25 and the page number “1” in a further page type field, use the rule set for the first page. The conditions for the last page would say that one of the page type fields 25 must contain the datum “Invoice” and that the page number and the total page number are contained in a further page type field 25, and when both are the same it is the last page, such that the corresponding rule set must be used. Furthermore, it is possible to provide corresponding character- and/or structure-related functions for regions with which one rule or a rule set is generated, applied and/or changed. Given the application of an exchange function, a rule set could be changed or another rule set could be applied when the content (such as, for example, a character or a character sequence of a source data field) within a region has changed relative to the corresponding source data field of the same, region of the previously processed input document data. Given the application of a contain function, a predetermined rule set for a region could be used when a character or a character sequence of a specific source data field has a specific content. Naturally, other possible functions can be specified without further measures.

A computer program product and a system with in particular graphical means for input of such conditions are provided with the method according to the second aspect of the preferred embodiment. These structures comprise a window on the graphical user interface in which contents of page type fields 25 can be linked by means of logical linking. If the logical result of the linking is “true”, this thus means that this rule set is to be drawn upon for the respective page. The structures for input of the conditions advantageously also comprise typical logical link structures such as, for example, the comparison of the page number with the total page number, whereby only the corresponding page type fields 25 that can be used alone or in connection with further logical links are then to be associated with these link structures. Furthermore, the structures for input of conditions for repeat structures and/or rules of the rule data set can comprise character functions such as, for example, the function CONTAIN, with which a specific character sequence is sought in a source data field or source data region, or the function EXCHANGE, with which it is checked whether a specific data value in a source data field and/or source data region has changed relative to a corresponding, previously valid data value. The last cited function is in particular useful in the processing of successive pages and/or repeat structures.

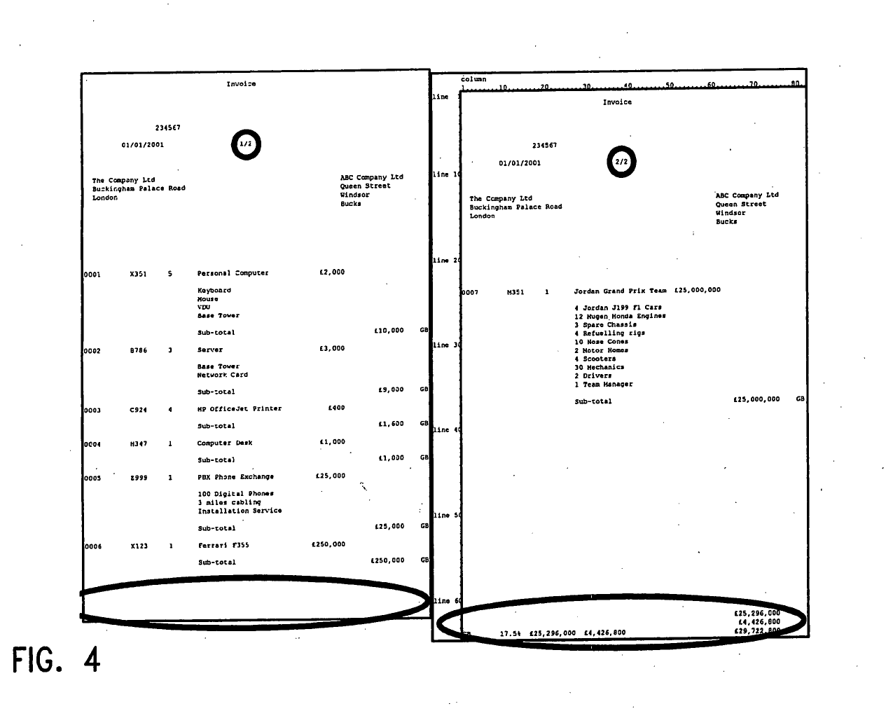

Since an input document data stream can contain multiple documents and a structured data file for each document should contain a complete set of data fields, it is appropriate to determine the start and the end of each document so that the start and the end of a document are automatically detected in the conversion. For this, document boundary fields 26 are defined (FIG. 4) and document boundary conditions are input. The document boundary fields are typically elements of a letterhead, page numbers or closure elements in bills or the like. The document boundary fields 26 can concern the same data as the page type fields 25 or the source data fields 23. They differ from these further fields in that they are used in conditions for determination of the start or the end of a document. These conditions can be input in the same manner as the conditions for determination of the page type.

Given the establishment of END conditions for nested and/or hierarchically structured regions, it is in particular useful to completely couple the END condition of a first region to the END condition of a second region, in particular to couple the END condition of a subordinate region to the END condition of a superordinate region.

Different document types such as, for example, reminders, delivery receipts, bills, etc. can also be contained within an input document data stream. The rule sets of the individual document types can be designed such that a separate structured data file is generated for each document type. The data of different document types can also be stored in a common structured data file.

The source data fields can in principle be addressed absolutely in line data streams, meaning, for example, by means of the line number, the character number within the respective line and the length, i.e. the number of the characters. Such an addressing can be simply established and is automatically adopted by the system as soon as a source data field is defined in the template document.

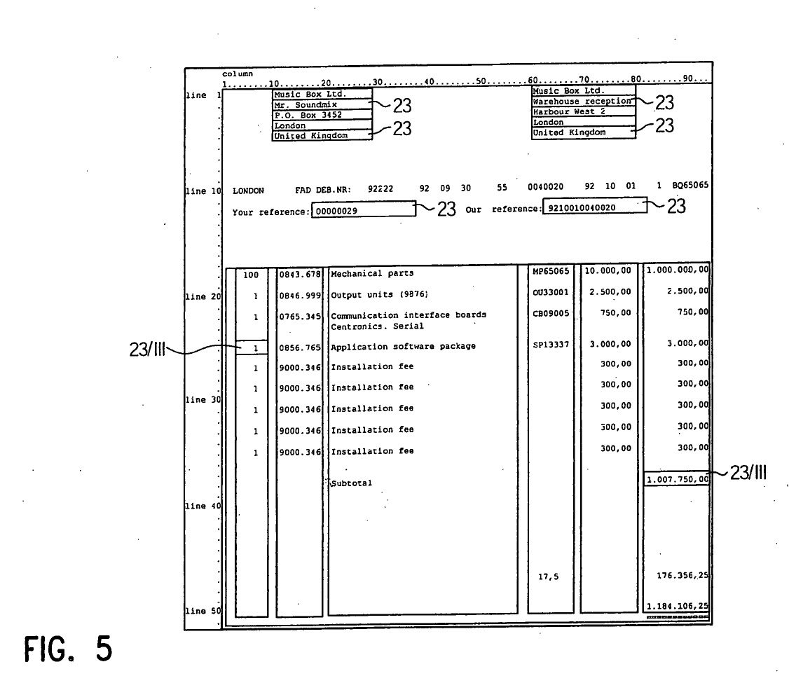

FIG. 5 shows a plurality of source data fields 23, whereby two source data fields 23, III are shown that are not suitable for such an absolute addressing.

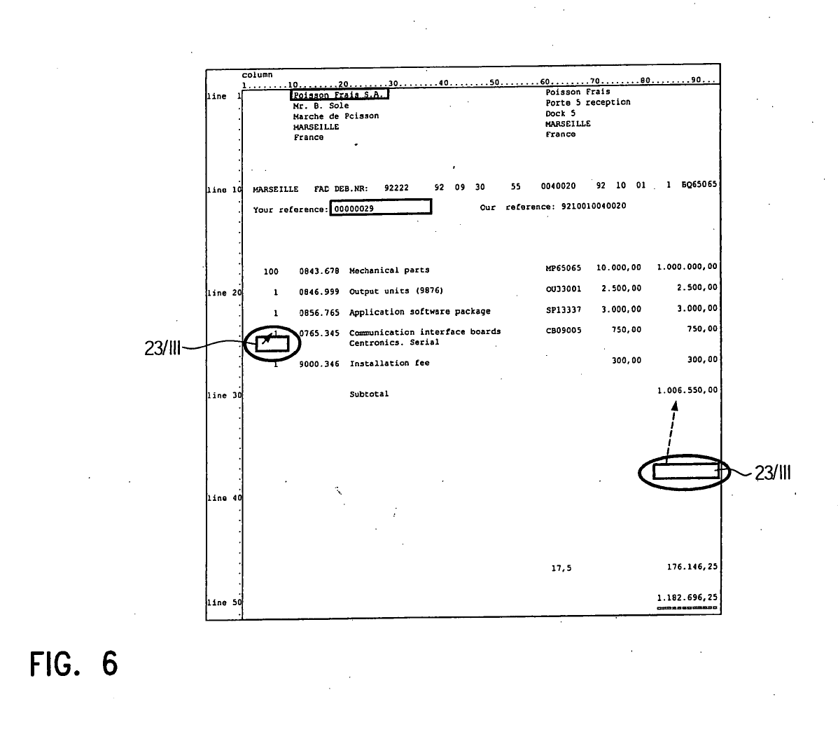

FIG. 6 shows a further document of the document type form FIG. 5 in which, however, the source data fields 23/III are arranged offset relative to the data that they should map to the data fields. This means that the location of specific data is dependent on preceding data contained in the document. In FIG. 6, for example, the specification of the sum (“Subtotal”) has been displaced relative to the document from FIG. 5, since fewer items are contained in this bill than was the case in the template document.

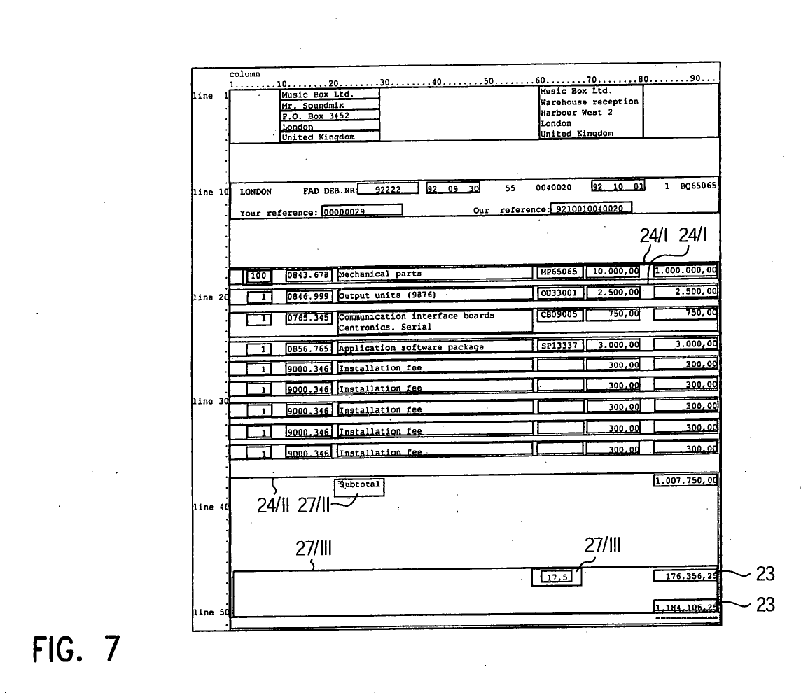

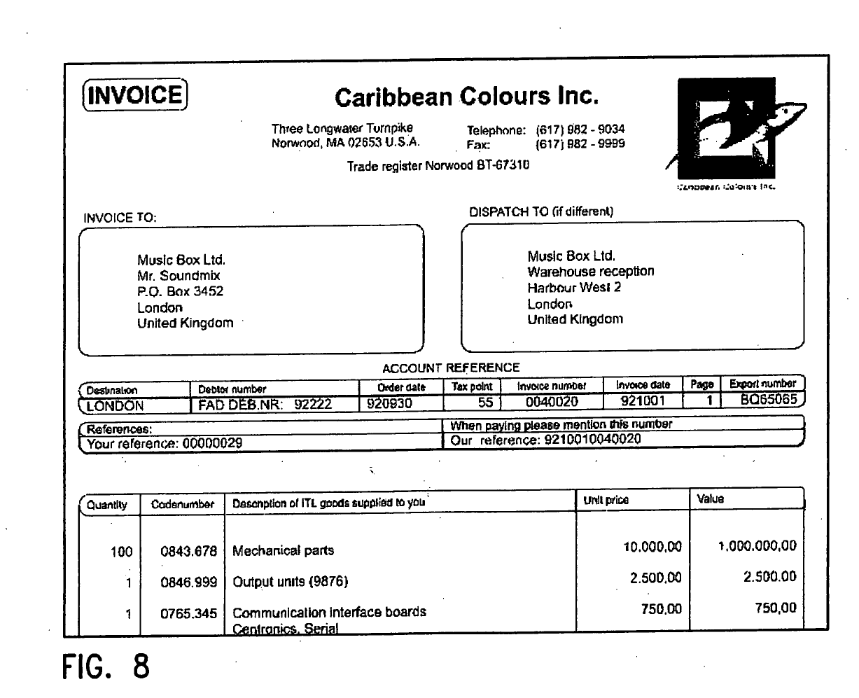

To remedy this problem, source data regions 24 are defined that respectively contain a position element 27 whose location is defined relatively. This position element 27 is typically but not necessarily a source data field 23. In the template document shown in FIG. 7, a source data range 24 is respectively defined for the individual items of the bill. Within such a source data region 24, the first entry is the number of the corresponding items, which is always a whole number. A condition according to which the source data region 24 is positioned can therefore be input that, in the present example, searches for a character sequence in which a whole number is sought and a row is arranged in the region of the characters (meaning columns) 4 through 8. If such a character sequence is found in the document, this source data region 24 is correspondingly positioned. The individual source data fields 23 are absolutely addressed within the source data region. In this example, the number of the items is not predetermined in a fixed manner. It is therefore possible that this source data region 24 is to be applied with differing frequency. It is herewith thus a repeatedly applied source data region 24. This is to be correspondingly established in the condition.

In this example, two further source data regions 24/II and 24/III are listed that are relatively addressed. The condition for location of the source data region 24/II reads: if the character sequence “Subtotal” is found at any location on the current processed page (CONTAIN function), it thus represents a position and repeat element of the source data region 24/II forming a repeat structure, which source data region 24/II comprises the line in which this character sequence is contained as well as all further lines up to the fiftieth line.

The condition for the source data region 24/III reads: if a character sequence is found in the region of the sixty-first to sixty-seventh character of a line within the source data region 24/II, the source data region 24/III comprises this line and all further subsequent lines within the source data region 24/II. The further source data fields 23 are addressed within the source data regions 24. The addressing can refer to an arbitrary reference point such as, for example, the first or last line within the source data region 24.

The source data regions 24/II and 24/III occur only once within a document, meaning that they are not repeat structures, which can be accounted for in the creation of the corresponding condition for positioning of the source data regions 24.

The structured data file that can be created with such a rule set contains data that, for example, are shown in FIG. 12 (as in the German patent application 10 2004 021 269.4) and are structured by page and region. Source data fields 23 can be associated with arbitrary corresponding data fields in the tree structure 21 at any point in the template document.

The structured data file thus forms a databank whose content can be read out simply and with typical means and be entered into arbitrary layouts or forms. The output documents so generated can be arbitrarily formatted and contain the data listed in the original line data stream. A section of such an output document is shown in FIG. 8.

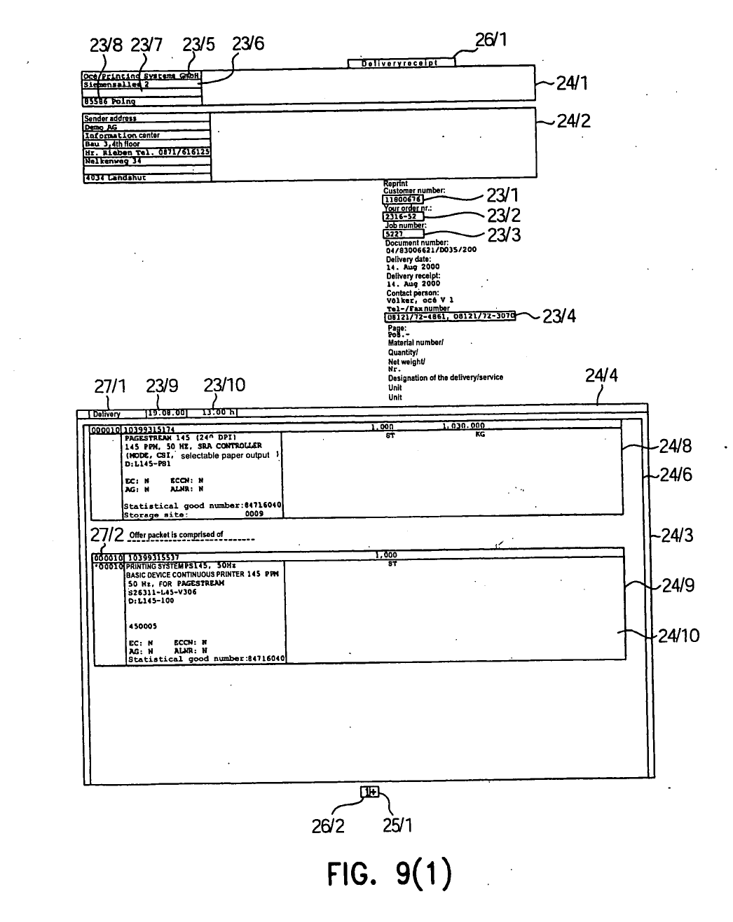

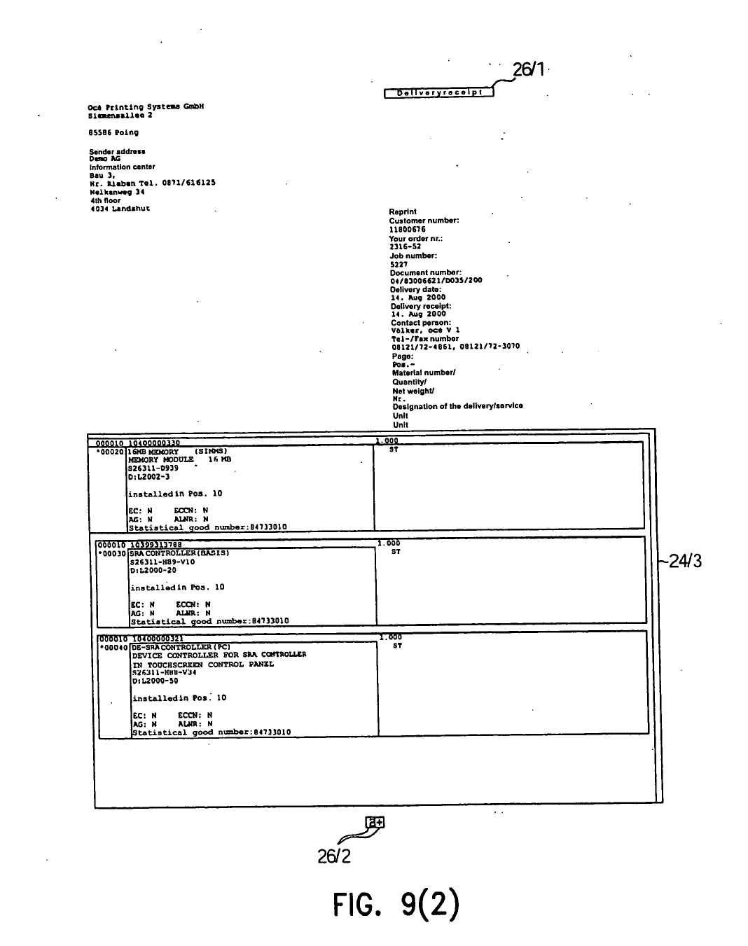

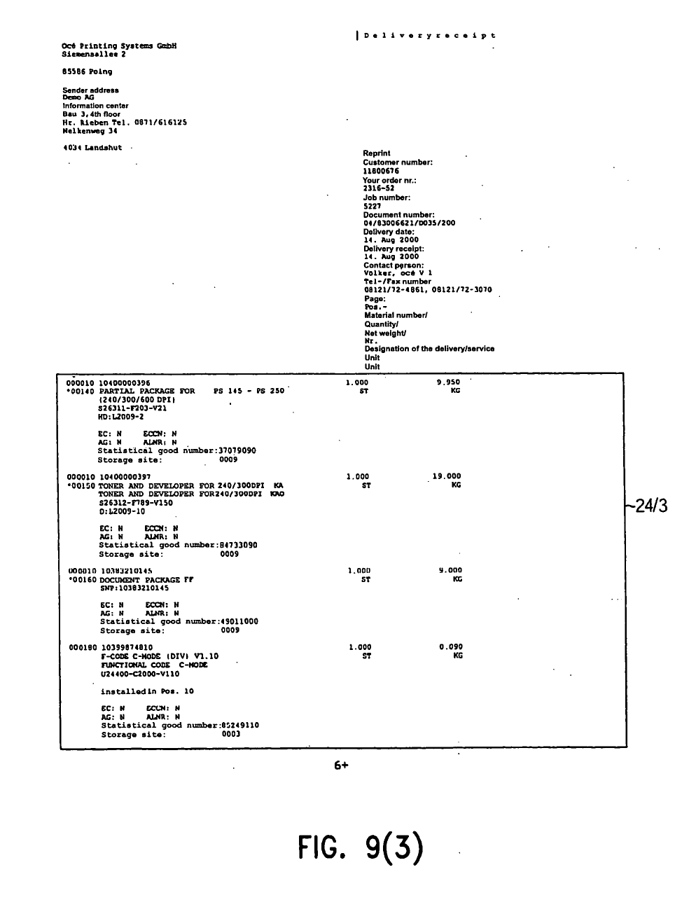

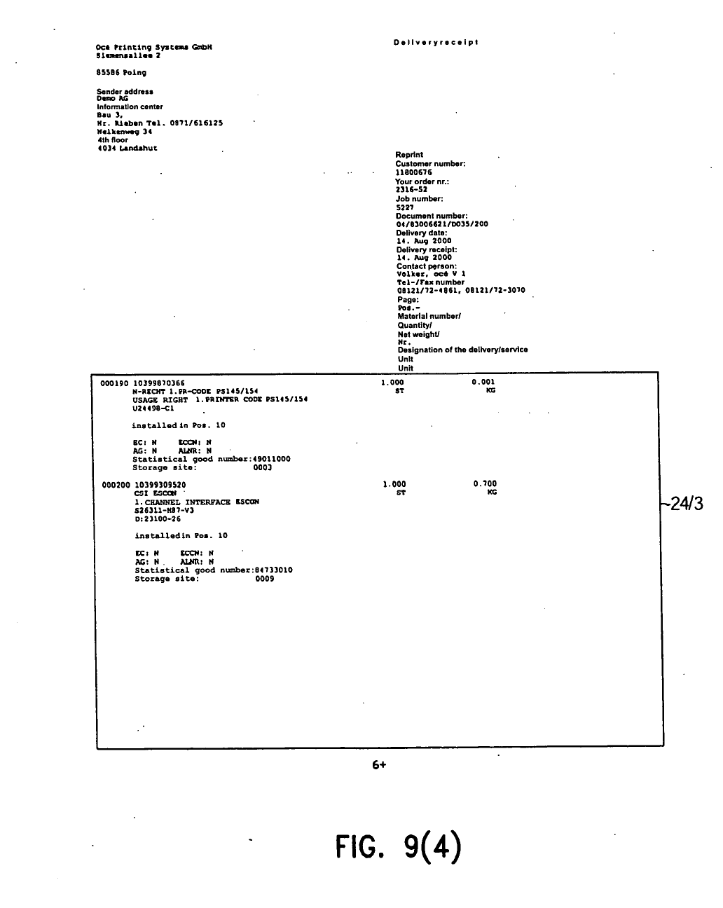

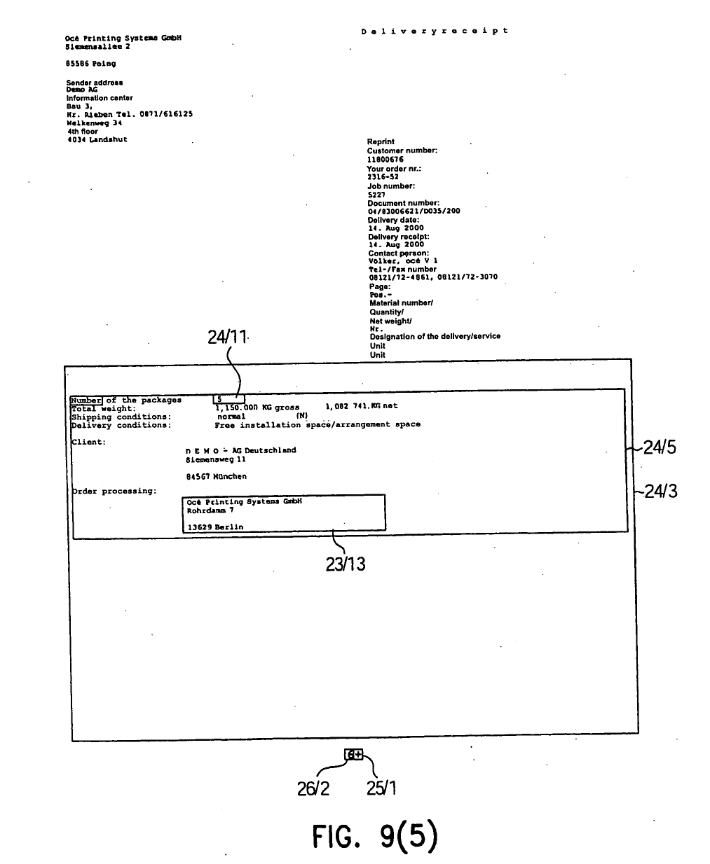

The rules and conditions for extraction of the data of the document “delivery receipt” (shown in sections in FIG. 9) are subsequently explained by way of example. The individual rules and conditions are listed in an attachment.

The tree structure of the mapping or structure elements for extraction of the data from the document “delivery receipt” is listed at the end of the attachment. The tree structure that serves as a template for generation of the structured data file and corresponds to the tree structure shown in FIG. 2 is shown on page 11 of the attachment.

The tree structure of the mapping elements contains the source data fields and source data regions according to which data are extracted from the documents.

The conditions and rules are organized corresponding to the tree structure of the mapping elements. The structure elements and properties that apply to the entire document, i.e. that relate to the mapping element “document”, are defined first (page 1 of the attachment).

The structure elements comprise repeat source data regions, source data fields, page types and control elements corresponding. to a repeat structure. All data and other information that can be logically linked given conditions are designated as control elements. Control elements are in particular page type fields, document boundary fields and position elements that respectively define a datum in a document as well as line numbers of specific lines. In the present exemplary embodiment, two page types “delivery receipt first page” and “delivery receipt following page” are defined for which a separate rule set is respectively specified. A repeat source data region “table” is also defined that can occur multiple times in a document, whereby here this is independent of the page type since it is respectively linked on both page types with the source data range “table region” defined there. Such a repeat source data region contains source data fields and/or source data regions. However, it contains no elements for its own positioning. The positioning occurs via the source data regions (here: “table region”) linked with it.

The character code for the line break, the character code for the page break and the character table as well as an operating list for detection of page types are defined as properties. The page type “delivery receipt first page” is detected using the condition that a page type field 1 26/1 (line 2 of the current processed page, characters 66-88) contains the character sequence “d e l i v e r y r e c e i p t” and a page type field 2 26/2 (line 87 of the current processed page, characters 83-84) contains the character “1”. The page type fields 26/1 and 26/2 are drawn in on page 1 and 2 of FIG. 9. For reasons of clarity, only a small selection of all control elements and source data regions are shown in FIG. 9.

The condition for detection of the page type “delivery receipt following page” states that the page type field 1 26/1 the character sequence “d e l i v e r y r e c e i p t” and the page type field 2 is not equal to “1”.

The definition of the page types again comprises structure elements and properties. The structure elements in turn comprise source data regions, source data fields and control elements. For the first page, three source data regions “sender” 24/1, “sender address” 24/2 and the source data range “table region” 24/3” are contained. This is linked with the repeat source data region “table” contained in the “document”. A series of source data fields that are arranged in none of these source data regions are also defined by means of absolute addressing. Here the source data fields “customer number” 23/1, “order number” 23/2, “job number” 23/3 and “tel/fax number” 23/4 are exemplarily listed. These source data fields are unambiguously defined via specification of the line numbers and via specification of the characters that they comprise within the respective line.

Conditions for positioning of the source data regions and a condition for detection of the document boundary are specified under the properties of this page type. In this exemplary embodiment, the source data regions are all absolutely positioned via the line number of the first line of the source data region, namely in the lines 3, 9 or 43. In the framework of the invention, it is naturally also possible to also establish the position of the source data regions relatively, for example via detection of a character sequence.

The end of the document is detected when a document boundary field 25/1 that is arranged immediately subsequent to a page number (page type field 26/2) contains the character “-”. This is not the case on page 1 in the present exemplary embodiment; the document therefore comprises multiple pages.

The definition of the following pages is designed similar to the definition of the first page, whereby the following pages differ in that they comprise only a single source data region, namely the “table region” 24/3.

The repeat source data region are defined on page 4 of the attachment. In the present application case, there is only one repeat source data region “table”. This is linked with the source data region “table range” and comprises three source data region “delivery” 24/4, “shipping instructions” 24/5 and “delivery items” 24/6. This shows the very advantageous property of an exemplary embodiment of the preferred embodiment, that a plurality of source data regions can be arranged nested, whereby in particular the positioning of a source data range that is arranged within a further source data region occurs with regard to the further source data region, meaning that the line numbering in the further source data region for the source data region arranged herein begins with the number “1”. The positioning of the source data region within a “superordinate source data occurs independent of the content of the document outside of the superordinate source data region.

In the repeat source data region “table”, the presence of the individual source data regions “delivery” 24/4, “shipping instructions” 24/5 and “delivery items” 24/6 is detected using the detection of specific character sequences with a CONTAIN function such as “delivery”, “number” or, respectively, with a numerical function for detection of a whole number value in the position elements 1 through 3.

The definition of the individual source data regions is subsequently explained in brief.

The source data region “sender” 24/1 contains four source data fields 23/5 through 23/8 that are absolutely addressed within the source data region ‘sender”. The condition for detection of the source data region end is also defined in that the line number is equal to “4”. This means that the source data region “sender” comprises four lines. The source data range “sender address” 24/2 (which, however, comprises seven lines) is also defined in a similar manner.

A source data region “table region 24/3 is linked with the repeat source data region “table” and contains the condition for detection of the source data region end.

The source data region “delivery” 24/4 comprises only a single line, namely here the first line of the source data region “table region” 24/3 with two source data fields “delivery date” 23/9 and “delivery time” 23/10.

The source data range “shipping instruction” contains a series of source data fields in which “number of packages” 23/11 as a field data field and the source data field “job handling” 23/12 are exemplarily marked on the last page in FIG. 9.

The source data region “delivery items” 24/6 comprises further source data regions “item description” 24/8 and “sub-items” 24/9. A condition list for detection of the contained source data regions “item description” 24/8 and “sub-items” 24/9” is listed in the source data region “delivery items”. The source data region “item description” 24/8 begins in the second line of the superordinate source data region “delivery items” 24/6. The source data region “item description” is thus addressed absolutely. The source data region “sub-items” 24/9 is addressed relatively, whereby the position element 27/1 is compared with the position element 27/2 and, given a correlation, it is established that the source data region “sub-items” 24/9 exists. The detection of these source data regions also defines the start of these source data regions.

Furthermore, a condition for detection of the end of the source data region “delivery items” is specified with which the end is detected via detection of a further delivery item or via detection of the table end.

Furthermore, the source data regions “item description” 24/8 and “sub-items” 24/9 are defined in detail, whereby the source data region “sub-items” contains a further source data region “sub-item description” 24/10.

The exemplary embodiment above shows how the source data fields 23 (which can also be arbitrarily combined and nested by means of the source data regions) in an input document are positioned by means of absolute and relative addressing in order to extract the data contained in the input document. These extracted data are automatically stored in a structured data file corresponding to the tree structure shown on page 11 of the attachment.

The exemplary embodiment shown above shows the rule sets for both page types and the conditions for detection of the document or page boundaries. The fundamental structure for definition of the individual elements such as document, page type and source data region comprise source data regions, source data fields and control elements. Only the element “document” contains the definition of repeat source data regions, page types and definitions regarding fundamental properties of the document. In the framework of the present preferred embodiment, the page types can also be considered as source data regions since they are defined with the same structure as the actual source data region.

Furthermore, the above exemplary embodiment shows that specific further source data regions such as, for example, the source data regions “delivery”, “shipping instructions” and “delivery items” are associated with specific types of source data regions such as, for example, the source data region “table”, such that the further source data regions only occur in a superordinate source data region (here “table”).

Given the extraction of the data, it is detected by means of source data region pointer from which source data regions current data are extracted. This pointer thus also corresponds to an indicator of the level of the tree structure of the mapping elements (page 10 of the attachment). The largest source region hereby corresponds to the entire document. At the end of a page, the source data region pointer is changed such that it points to the entire document. In the event of a source data region that is linked with a repeat source data region and thus can extend beyond a page end to a subsequent page (meaning that this source data region extends beyond the page end to a following page), the value of the source data region pointer with which this has pointed to this source data region is stored in an additional page change pointer. Given processing of the following page, upon reaching this source data region (meaning that the source data region pointer again assumes the same value as the page change pointer) the corresponding data set in the structured data file is extended and no new data set is started for this source data region.

The preferred embodiment is explained above in detail using an example in which the source data regions always extend over the same page width. However, in the framework of the preferred embodiment it is also possible to define source data regions that merely extend over a part of one or more successive lines. These source data regions thus form columns in the respective document, whereby a plurality of such columnar source data regions can be arranged next to each other. These columnar source data regions are primarily suitable for readout of tables.

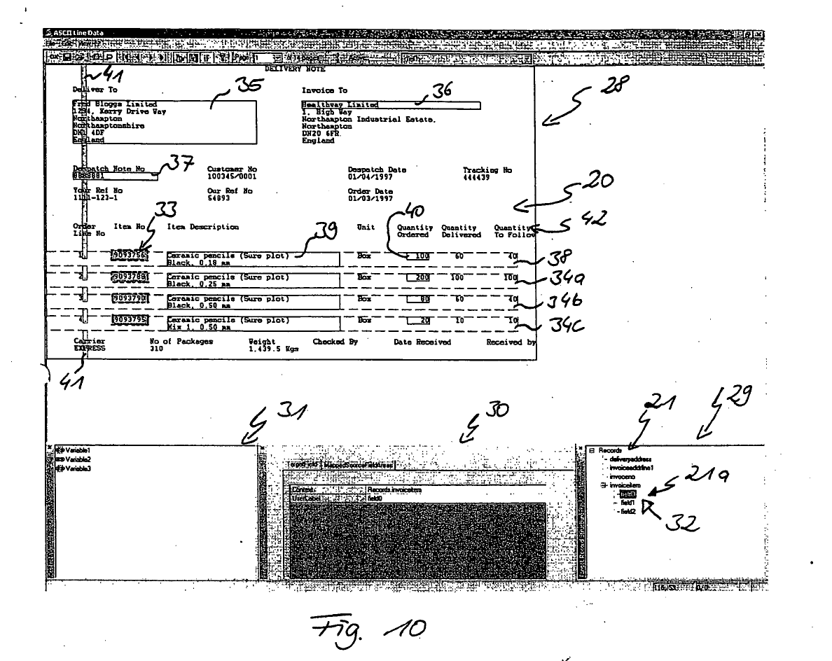

The design of a screen display effected via a computer program product according to the second aspect of the preferred embodiment is shown in FIG. 10. The template document 20 is thereby reproduced in a first screen window 28, the tree structure 21 in a second screen window 29. The data field “field0” 32 is currently marked under the data field “invoiceitem” in the window 29. All source data fields 33 standing under the heading “Item NO” are accordingly emphasized in the template document 20 via a double border. In the third window 30, structural information regarding the marked data field 32 (field0) are displayed in the third window 30. These structural associations such as, for example, variable type (character, integer, flow) can be adjusted via the window 30.

All variables that are used for process control, for example variables for repeat elements or for detection of END conditions, are displayed in the window 31. New variables can also be defined and associations with source data fields in the template document 20 (likewise with imaginary lines) can also be effected in the window 32. For example, Variable2 is associated with the content of the region 41. This variable is used in order to check the repeat group rule, i.e. whether the content of the Variable2 is identical with a point.

All type-specific properties of marking regions or data fields are displayed in the window 30. They can also be changed via window 30 in the framework of the stored rules corresponding to the process logic. Since the field0 is directly marked in the window 29, all properties belonging to the field0 are displayed in the window 30.

In the exemplary embodiment of FIG. 10, four regions or source data fields are associated with the structure of the template document 20 displayed in the window 28, namely: the data field “Delivery address” associated with the region 35 marked in the template document 20, with which data field a character variable is associated in the structured file, which character variable can comprise a plurality of characters inclusive of line break control characters; the source data field 36 with the content “Healthway Limited”; the data field “invoiceaddrline 1” in the tree structure 21; and the data field 37 of the template document 20; the data field “invoceno” in the tree structure 21. In the tree structure 21, the ARRAY “invoiceitem” is associated as a structure element with the region 38 (in which three data fields 33, 39 and 40 are marked in turn) marked in the template document 20, with which ARRAY the data fields field0, field1 and field2 are in turn associated as subordinate structure elements. Field0 corresponds to the source data field 33, field1 corresponds to the source data range 39 and field2 corresponds to the source data field 40.

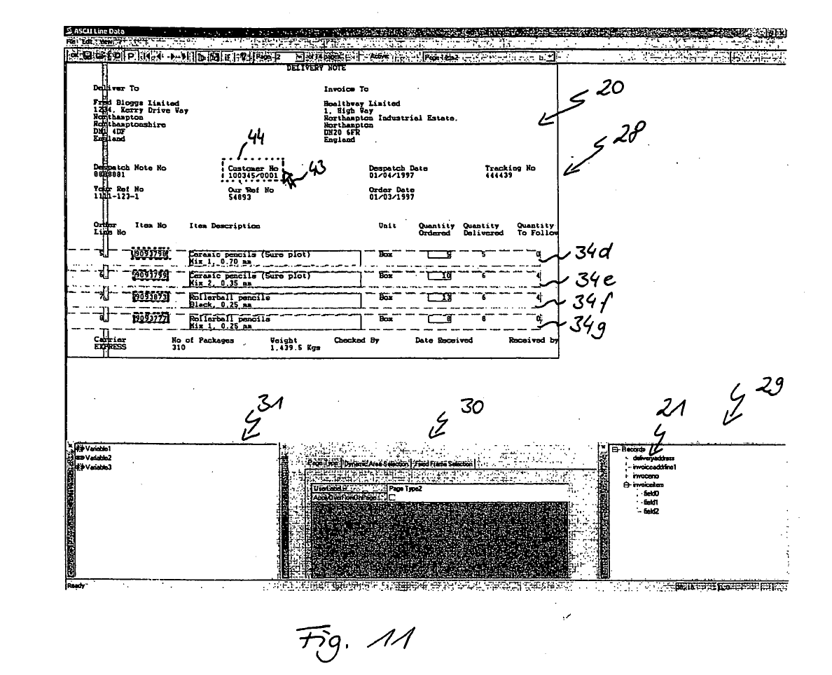

Furthermore, the property is assigned to the marked region 38 that it represents a repeat group, meaning that its structure occurs multiple times in the template document 20 and that thermodynamic corresponding data of the input document data stream are respectively associated with the same data field in the tree structure 21. The corresponding repeat groups of the template document 20 are designated in FIGS. 10 and 11 with the reference characters 34a, 34b, 34c, 34d, 34e, 34f and 34g. In the present case, the condition for a repeat group is that a point is respectively situated in a line at the third position (column). In the template document 20, these are the order line numbers listed in the job table 42 with the values 1., 2., 3., etc. The repeat group is thus sought in the third column (which is provided with the reference character 41 in FIG. 10) in the manner (shown in an x-y matrix) of the template document 20. In all following pages of the template document 20, the corresponding following entries are automatically detected due to the repeat rule and the data field structure associated with the repeat region 38 or 34, which is clear (for example in FIG. 11) for the following entries 5. through 8. (repeat groups 34d through 34g). From the input data stream or the template document 20, the variable data (such as, for example, the data contained in the data fields 33, 39 and 40) forming the basis of the input data stream can thus be differentiated (and, if applicable, separated) from static (meaning recurring) data. For example, in the present case the data of the source data fields or regions 35, 36, 37 (which appear again with the same content on following pages of the template document 20, which however are only required once for preparation of an input data stream according to the first aspect of the preferred embodiment) are detected as static and their reappearances are ignored in the reformatting of the data stream.

Due to the possibility in a computer-aided manner of using graphic-oriented aids, in particular such as the possibility to arbitrarily establish one or more source data fields in rows and columns with a rectangle, the corresponding rules can be automatically created without further techniques. To establish the region 38 as a repeat group, on the screen in the window 28 a rectangle is initially drawn around all data (shown in FIG. 10) of the marked region using a computer mouse. The relevant source data fields 33, 39 and 40 are then respectively individually marked and associated with them, and their corresponding data fields in the tree structure 21 are associated as a sub-structure with the object invoiceitem defined as a field (ARRAY). Furthermore, if invoiceitem is defined as a repeat group and as a repeat rule as already described above, the location of a point in the third column of a line is established. On the one hand, as an end for the repeat group it can be defined that a document end (structure “document” superordinate to the region 38 o “Records” in the tree structure) occurs and/or a condition ending the occurrence of the repeat group is fulfilled, for example that a new name (content) occurs in the source data field 36 and a variable of the window 31 connected with this.

The region 39 with which the variable field1 is associated represents a level-spanning marking region nested with the region 38. Given color display of the windows 28 and 29, similar structure elements such as, for example, the marked region 38 and its repeat groups 34a through 34g as well as the corresponding structure element invoiceitem in the tree structure 21 are shown in a first color, for example red. The region 39 and the repeat groups corresponding to this in the window 28 are alternatively displayed in a second color (for example blue) or (as is clear in FIGS. 10 and 11) graphically contrasted (via drawn lines) from the dashed lines of the marked region 38 and its repeat groups 34a through 34g.

In the window 30 of FIG. 11 it is indicated that the data of the template document 20 displayed in the window 28 are to be associated with a second page type (page type 2). This display and association can occur either automatically based on corresponding data of the input document data stream or be adjusted by the user (in particular in a menu-driven manner) via window 30.

As is to be seen in FIG. 11, in the template document 20, the template document can be navigated with a mouse pointer 43. When the mouse pointer 43 moves in the proximity of an item of information, a region 44 is automatically displayed that is detected (in a computer-aided manner) as an associated range. It can thereby in particular be taken into account that data form an associated area (as in the case of FIG. 11) that is completely surrounded by space characters. Furthermore, the history of the processing of the template document 20 can be taken into account, meaning that data that have already been marked before or are detected as repeat groups are not automatically suggested for re-marking. A further suggestion with regard to the structure element in the tree structure 21, for example whether an ARRAY should be placed or only a data field, can be made at the press of a button, for example with the right mouse button. A selection can correspondingly be offered as to whether a repeat group or a non-recurring data field should be placed.

The preferred embodiment is subsequently briefly summarized:

With the method of the preferred embodiment, source data fields in the input document data stream are automatically positioned for readout of data to be extracted, whereby their positioning occurs by means of absolute or relative addressing. In particular the source data fields can be positioned by means of source data regions with which sections of the individual documents are detected. These source data regions can be arranged nested and can themselves in turn be positioned absolutely or relatively.

The corresponding rules can simply be created via marking of the corresponding source data regions and source data fields in a template document.

The preferred embodiment in particular is suited to be realized as a computer program (software). It can therewith be distributed as a computer program module as a file on a data medium such as a diskette, DVD- or CD-ROM or as a file over a data or communication network. Such and comparable computer program products or computer program elements are embodiments. The workflow of the preferred embodiment can be applied in a computer, in a printing device or in a printing system with upstream or downstream data processing devices. It is thereby clear that corresponding computers on which the preferred embodiment is applied can contain further known technical devices such as input structures (keyboard, mouse, touchscreen), a microprocessor, a data or control bus, a display device (monitor, display) as well as a working storage, a fixed disk storage and a network card.

[image]

[image]

[image]

[image]

[image]

[image]

[image]

[image]

[image]

[image]

1-64. (canceled)

65. A method for conversion of an input document data stream with one or more documents into a structured data file for generation of an output document data stream, comprising the steps of:
extracting data from the input document data stream according to a predetermined rule set and storing the data in the structured data file;
associating field names with individual data fields in the structured data file and structuring the data fields in a plurality of data levels; and
designing the rule set such that arbitrary data from the input document data stream are mapped to an arbitrary data field of the structured data file.

66. A method according to claim 65 wherein individual rules of the rule set are created, in that a template document are shown in one window on a graphical user interface and data fields in a tree structure are shown in another window, and a source data field is respectively defined via marking of data in the template document, and upon linking of such a source data field of the template document with a data field a rule is automatically created in order to read a source data field out from the input document data stream and to store its content in a corresponding data field according to the structured data file.

67. A method according to claim 65 wherein the input document data stream is sub-divided into a plurality of documents, a structured data set being stored for each document in the structured data file.

68. A method according to claim 65 wherein the documents comprise a plurality of pages, the data being extracted page-by-page.

69. A method according to claim 65 wherein the input document data stream merely comprises characters that are encoded by means of at least one character table, line break, and page break.

70. A method according to claim 65 wherein the input document data stream comprises characters that are encoded by means of a single character table, line break, and page break.

71. A method according to claim 69 wherein the line or page break is respectively encoded via a specific character sequence.

72. A method according to claim 69 wherein the line or page break is respectively encoded via a specific number of characters or lines respectively.

73. A method according to claim 65 wherein data are extracted from the input document data stream, said data being arranged in specific source fields in the input document data stream, the source fields being defined by a line number in a respective page and a character number in a respective line.

74. A method according to claim 65 wherein data are extracted from the input document data stream, said data being arranged in specific source fields in the input document data stream, the source fields being defined by line number and character number in the respective line within a specific source region in a document.

75. A method according to claim 74 wherein at least one position element of the source data region is defined in the document or in the source data region.

76. A method according to claim 75 wherein a plurality of position elements of the source data region are defined in a respective page or in a further source data region.

77. A method according to claim 75 wherein the position element or the source data region is defined as an absolute location via specification of a line count and a character count within a respective line in a respective page or in a further source data region.

78. A method according to claim 75 wherein the position element or the source data region is defined as a relative location of a specific character sequence in a respective page or in a further source data region.

79. A method according to claim 78 wherein the character sequence is either spatially independent, is arranged in a certain region, or is arranged at a location defined by the line count and the character count within the line in the respective page or in the further source data region.

80. A method according to claim 74 wherein a plurality of source fields are arranged in the source data region.

81. A method according to claim 74 wherein a plurality of source data regions are arranged in a further source data region.

82. A method according to claim 75 wherein a first source data region is defined that is associated with a further second source data region, such that the first source data region occurs only in the second source data region.

83. A method according to any of the claim 76 wherein upon extraction, it is detected by means of a source data region pointer from which source data region current data are extracted, a largest source data region corresponding to an entire document and at an end of a page the source data region pointer indicating the entire document; and in the event that a region with an end condition at a page end should not yet be completely processed, a value pointing to said source data region is stored in a page change pointer such that upon processing of a following page after processing of page-typical lines said source data region is continued with until the end condition is reached.

84. A method according to claim 75 wherein a specific source data region is detected multiple times within an input document, and the rule set defining said source data region is applied correspondingly often for extraction of data and storage of the data in the source data region.

85. A method according to claim 65 wherein the rule set is defined by means of source data fields that are positioned in the input document data stream at data to be extracted, the positioning occurring by means of absolute or relative addressing.

86. A method according to claim 85 wherein the positioning of the source data fields occurs by means of source data regions in which one or more source data fields or further source data regions are respectively arranged.

87. A method according to claim 86 wherein the source data regions comprise further source data regions, source data fields, or control elements as structure elements, where conditions for detection of the document or page boundaries or for searching for altered characters or character sequences or conditions for positioning of source data regions are defined by logically linked control elements.

88. A method of claim 65 wherein for creation of at least one rule of the rule set at least one template document that corresponds to a format of the documents contained in the input document data stream is shown in a first window via a graphical user interface with a plurality of windows, the data fields are arranged in a tree structure in a second window; and a source datum of the template document is marked with a graphical structure; or a plurality of source data of the template document are marked as a marked region belonging together, and at least one structure element corresponding to the marking region is assigned to the marking region.

89. A method according to claim 88 wherein the at least one structure element is additionally assigned to the tree structure and is represented therein.

90. A method according to claim 88 wherein the at least one structure element is associated with a branch of the tree structure.

91. A method according to claim 88 wherein an element corresponding to a page type, a data field, a table or a range comprising a plurality of data fields is associated with the at least one structure element with the marking region.

92. A method according to claim 88 wherein the template document is shown in rows and columns, and the marking region is freely selectable in rows and columns.

93. A method according to claim 88 wherein a repeat element that is characteristic for a structure recurring in the template document and what is known as a repeat structure is selected in the template document; and structurally characteristic data of the repeat element are detected manually, semi-automatically in a menu-driven manner, or automatically.

94. A method according to claim 93 wherein a repeat rule is formed, and with said repeat rule all associated data of a repeat structure is automatically detected in the template document or in the input document data stream.

95. A method according to claim 93 wherein an element or a region within the template document is selected with a pointer device and available association possibilities are automatically displayed in context-relative manner as said repeat element region.

96. A method according to claim 93 wherein at least one associable element or at least one associable region of the template document is automatically displayed emphasized in the template document dependent on a position of a pointer device.

97. A method according to claim 93 wherein a repeat region comprising a plurality of data is marked in the template document and, dependent on menu-driven selection made by an operating personnel, a structure element corresponding to the selection is associated with said region.

98. A method according to claim 88 wherein an END condition for the marking region or a repeat region is established automatically, semi-automatically in a menu-driven manner, or manually.

99. A method according to claim 88 wherein a branch in the tree structure is applied as said structure element, and a field of a type ARRAY that corresponds to the branch is applied in the structured data file.

100. A method according to claim 99 wherein a plurality of data fields as subordinate structure elements are associated with the branch in the tree structure; and new data fields are first alternatively established for creation or expansion of the tree structure and then is associated with a superordinate branch; or the branch is established first and then new subordinate data fields are associated with it.

101. A method according to claim 93 wherein the repeat element is formed by one or more characters, a table, a document line, a document column, a table row, or a table column.

102. A method according to claim 93 wherein the repeat element lies in the marking region.

103. A method according to claim 93 wherein the repeat element is established with creation of the marking region belonging together therewith.

104. A method according to claim 93 wherein the repeat element is established before creation of the marking region belonging together therewith.

105. A method according to claim 93 wherein data of the repeat structure are automatically determined or displayed marked in the template document or in the input document data stream using structurally characteristic features of the repeat element.

106. A method according to claim 88 wherein the marking region contains source data fields linked with at least one structure element of the tree structure designed as a data field, whereby given such a linking a rule is automatically created for readout of a source data field from the input document data stream and for storage of its content in the structured data file in the corresponding data field.

107. A method according to claim 93 wherein via establishment of the repeat structure or of the repeat element in the template document, it is selectably decided whether a new structure element corresponding to the repeat structure or the repeat element is subsequently to be added in an existing tree structure.

108. A method according to claim 93 wherein data fields of the data set that are associated with the repeat structure are associated with a new structure element as sub-structure elements.

109. A method according to claim 88 wherein a plurality of marking regions are marked in the template document, said marking regions being nested within one another in a manner that spans across levels.

110. A method according to claim 93 wherein a finding rule for finding the repeat structures in which the data structure contained in the marking region reoccurs in the template document is generated at the marking region, and with the finding rule it can be determined at which positions data of the template document are to be associated with the marking region.

111. A method according to claim 88 wherein an assignment of the structure element for marking occurs automatically using the structure element present in the template document.

112. A method according to claim 88 wherein an end condition for the marking region is automatically generated.

113. A method according to claim 112 wherein an end condition of a superordinate second region is automatically adopted for a first marking region that is subordinate to a second marking region.

114. A method according to claim 88 wherein an end condition for the marking region is generated or changed via a data-driven condition.

115. A method according to claim 88 wherein an operating personnel has creation, alteration and deletion authority over all rules of the rule set or the tree structure via a menu navigation.

116. A method according to claim 88 wherein all regions of the data stream that belong to a common structure element are similarly marked using subject localization exposures generated in the tree structure within a data stream simultaneously or successively displayed in a first window, said data stream containing at least one complete template document.

117. A method according to claim 88 wherein rules applicable for data shown in the first window are applied to the data to check the rule set.

118. A method according to claim 117 wherein the application of the rules to the data shown in the first window is graphically illustrated.

119. A method according to claim 118 wherein regions of various levels or types are variously marked in the data shown in the first window.

120. A method according to claim 117 wherein a structure element displayed in the second window is selected, and all regions shown in the first window that are associated with said structure element are automatically displayed.

121. A method according to claim 117 wherein with regard to a structure element selected in the second window, superordinate or subordinate structure elements associated with the structure element or symbols corresponding to a hierarchical classification are automatically displayed.

122. A computer program product for an execution on a computer and used for conversion of an input document data stream with one or more documents into a structured data file for generation of an output document data stream, said computer program product performing the steps of:
extracting data from the input document data stream according to a predetermined rule set and storing the data in the structure data file;
associating field names with individual data fields in the structured data file and structuring the data fields in a plurality of data levels; and
designing the rule set such that arbitrary data from the input document data stream are mapped to an arbitrary data field of the structured data file.

123. A computer program product of claim 122 performing the further steps of:
providing a graphical user interface with a plurality of windows, a template document being displayable in a first window, said template document corresponding to a format of documents contained in the input document data stream;
in a further window providing the data fields arranged in a tree structure that comprises multiple levels; providing structure for definition of source data fields and linking of the same with the data fields; and given such a linking automatically creating a rule for readout of a source data field from the input document data stream and for storage of its content in the structured data file in the corresponding data field.

124. A computer program product according to claim 122 wherein said structuring for definition of source data fields marks corresponding data.

125. A computer program product according to claim 122 wherein said structure for linking of source data fields with data fields comprises drawing a connection line between the respective source data field to the corresponding data field.

126. A computer program product according to claim 122 performing the further step of marking source data regions in the template document.

127. A system for conversion of an input document data stream with one or more documents into a structured data file for generation of an output document data stream, comprising:
a computer with an input and an associated display device, and a computer program product stored and executed on said computer; and
said computer program product performing the steps of
extracting data from the input document data stream according to a predetermined rule set and storing the data in the structure data file,
associating field names with individual data fields in the structured data file and structuring the data fields in a plurality of data levels, and
designing the rule set such that arbitrary data from the input document data stream are mapped to an arbitrary data field of the structured data file.
